(19) United States
(12) Patent Application Publication
(10) Pub. No.: US 2023/0388936 A1
(43) Pub. Date: Nov. 30, 2023

(54) POWER CONTROL FOR CONCURRENT TRANSMISSION SCENARIOS IN MULTI-BAND OPERATION

(71) Applicant: QUALCOMM Incorporated, San Diego, CA (US)

(72) Inventors: Abhijit Bhattacharya, Bangalore (IN); Arul Durai Murugan Palanivelu, Bangalore (IN); Phanimithra Gangalakurti, Bangalore (IN); Thomas Mathew, Bangalore (IN)

(21) Appl. No.: 17/752,719

(22) Filed: May 24, 2022

(51) Int. Cl. H04W 52/16; H04W 52/36; H04W 52/34; H04W 52/54

(52) U.S. Cl. CPC H04W 52/16; H04W 52/367; H04W 52/34; H04W 52/54

(57) ABSTRACT

Methods, systems, and devices for wireless communications are described. In some aspects, a device may support multi-link operation (MLO) and may include a first arbitration block that manages communication on a first radio link and a second arbitration block that manages communication on a second radio link. The first arbitration block and the second arbitration block may support a signaling mechanism according to which each of the first arbitration block and the second arbitration block share or exchange information relating to a transmit power used on their respective radio link. For example, the first arbitration block may transmit, to the second arbitration block, an indication of a first transmit power for a first transmission on the first radio link and the second arbitration block may use the indication of the first transmit power to select a second transmit power for a second transmission on the second radio link.

### BACKGROUND

The following relates to wireless communications, including power control for concurrent transmission scenarios in multi-band operation.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a WLAN, such as a Wi-Fi (i.e., Institute of Electrical and Electronics Engineers (IEEE) 802.11) network may include AP that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via DL and UL. The DL (or forward link) may refer to the communication link from the AP to the STA, and the UL (or reverse link) may refer to the communication link from the STA to the AP.

Some devices may support concurrent transmissions across multiple bands. In some scenarios, concurrent transmissions may result in a high internal temperature of the device, which may cause the device to enter periods during which the device is unable to transmit. As such, the device may experience lower data rates and higher latency.

### SUMMARY

The described techniques relate to improved methods, systems, devices, or apparatuses that support power control for concurrent transmission scenarios in multi-band operation. For example, the described techniques provide for intra-device communication and cooperation between different transmit chains of the device to adjust a transmit power of an upcoming transmission in view of one or more ongoing transmissions at the device. In some implementations, for example, a first arbitration block of the device may control communication on a first radio link and a second arbitration block may control communication on a second radio link and the two arbitration blocks may exchange information relating to a transmit power used for transmissions on the two different radio links. For instance, the first arbitration block may schedule a first transmission on the first radio link with a first transmit power and may transmit an indication of the first transmit power to the second arbitration block. As such, if the second arbitration block receives a request, from a protocol data unit (PDU) generation block associated with the second radio link, for a transmission on the second radio link that at least partially overlaps in time with the first transmission, the second arbitration block may use the indication of the first transmit power to select a second transmit power for the second transmission on the second radio link.

A method for wireless communication at a device is described. The method may include receiving, from a first arbitration block associated with a first radio link and at a second arbitration block associated with a second radio link, an indication of a first transmit power for a first transmission on the first radio link, receiving, from a PDU generation block associated with the second radio link and at the second arbitration block, a request for a default transmit power for a second transmission on the second radio link, transmitting, to the PDU generation block from the second arbitration block, an indication of a second transmit power for the second transmission on the second radio link based on the request for the default transmit power and the indication of the first transmit power for the first transmission on the first radio link, and transmitting, to the first arbitration block from the second arbitration block, an indication of the second transmit power for the second transmission on the second radio link.

An apparatus for wireless communication at a device is described. The apparatus may include a processor, memory coupled with the processor, and instructions stored in the memory. The instructions may be executable by the processor to cause the apparatus to receive, from a first arbitration block associated with a first radio link and at a second arbitration block associated with a second radio link, an indication of a first transmit power for a first transmission on the first radio link, receive, from a PDU generation block associated with the second radio link and at the second arbitration block, a request for a default transmit power for a second transmission on the second radio link, transmit, to the PDU generation block from the second arbitration block, an indication of a second transmit power for the second transmission on the second radio link based on the request for the default transmit power and the indication of the first transmit power for the first transmission on the first radio link, and transmit, to the first arbitration block from the second arbitration block, an indication of the second transmit power for the second transmission on the second radio link.

Another apparatus for wireless communication at a device is described. The apparatus may include means for receiving, from a first arbitration block associated with a first radio link and at a second arbitration block associated with a second radio link, an indication of a first transmit power for a first transmission on the first radio link, means for receiving, from a PDU generation block associated with the second radio link and at the second arbitration block, a request for a default transmit power for a second transmission on the second radio link, means for transmitting, to the PDU generation block from the second arbitration block, an indication of a second transmit power for the second transmission on the second radio link based on the request for the default transmit power and the indication of the first transmit power for the first transmission on the first radio link, and means for transmitting, to the first arbitration block from the second arbitration block, an indication of the second transmit power for the second transmission on the second radio link.

A non-transitory computer-readable medium storing code for wireless communication at a device is described. The code may include instructions executable by a processor to receive, from a first arbitration block associated with a first radio link and at a second arbitration block associated with a second radio link, an indication of a first transmit power for a first transmission on the first radio link, receive, from a PDU generation block associated with the second radio link and at the second arbitration block, a request for a default transmit power for a second transmission on the second radio link, transmit, to the PDU generation block from the second arbitration block, an indication of a second transmit power for the second transmission on the second radio link based on the request for the default transmit power and the indication of the first transmit power for the first transmission on the first radio link, and transmit, to the first arbitration block from the second arbitration block, an indication of the second transmit power for the second transmission on the second radio link.

Some examples of the method, apparatuses, and non-transitory computer-readable medium described herein may further include operations, features, means, or instructions for determining a remaining available transmit power of the device based on the first transmit power for the first transmission and a transmit power constraint of the device, comparing the default transmit power to the remaining available transmit power, and selecting the second transmit power for the second transmission based on comparing the default transmit power to the remaining available transmit power, where transmitting the indication of the second transmit power to the PDU generation block may be based on selecting the second transmit power.

In some examples of the method, apparatuses, and non-transitory computer-readable medium described herein, the second transmit power may be equal to the default transmit power if the remaining available transmit power may be greater than the default transmit power; or the second transmit power may be less than the default transmit power if the remaining available transmit power may be less than the default transmit power.

Some examples of the method, apparatuses, and non-transitory computer-readable medium described herein may further include operations, features, means, or instructions for selecting the second transmit power for the second transmission based on the first transmit power for the first transmission and a mapping, where transmitting the indication of the second transmit power to the PDU generation block may be based on selecting the second transmit power.

In some examples of the method, apparatuses, and non-transitory computer-readable medium described herein, the mapping may be associated with a set of multiple threshold transmit powers for the first transmission on the first radio link; and each threshold transmit power of the set of multiple threshold transmit powers for the first transmission on the first radio link corresponds to a different transmit power for the second transmission on the second radio link in accordance with the mapping.

In some examples of the method, apparatuses, and non-transitory computer-readable medium described herein, the mapping indicates a correspondence between a first set of potential transmit powers for an ongoing transmission on the first radio link and a second set of potential transmit powers for an upcoming transmission on the second radio link that at least partially overlaps in time with the ongoing transmission on the first radio link; and a transmit power of the first set of potential transmit powers and a corresponding transmit power of the second set of potential transmit powers satisfy a transmit power constraint of the device based on the mapping.

Some examples of the method, apparatuses, and non-transitory computer-readable medium described herein may further include operations, features, means, or instructions for dropping the second transmission based on a transmit power delta between the default transmit power and the second transmit power satisfying a threshold transmit power delta associated with aborting the second transmission.

Some examples of the method, apparatuses, and non-transitory computer-readable medium described herein may further include operations, features, means, or instructions for obtaining a scheduling command associated with the second transmission that indicates the second transmission may be a latency-sensitive transmission and performing the second transmission in accordance with the second transmit power regardless of whether a transmit power delta between the default transmit power and the second transmit power satisfies a threshold transmit power delta associated with aborting the second transmission based on the second transmission being the latency-sensitive transmission.

Some examples of the method, apparatuses, and non-transitory computer-readable medium described herein may further include operations, features, means, or instructions for obtaining a scheduling command associated with the second transmission that indicates a mapping between a transmit power delta between the default transmit power and the second transmit power and a modulation and coding scheme index, selecting a modulation and coding scheme for the second transmission based on the transmit power delta and the mapping, and performing the second transmission in accordance with the second transmit power and the modulation and coding scheme.

Some examples of the method, apparatuses, and non-transitory computer-readable medium described herein may further include operations, features, means, or instructions for dropping a portion of the first transmission that overlaps in time with the second transmission based on the second transmission being associated with a higher priority than the first transmission and based on a transmit power delta between the default transmit power and the second transmit power and performing the second transmission in accordance with the default transmit power based on dropping the portion of the first transmission that overlaps in time with the second transmission.

In some examples of the method, apparatuses, and non-transitory computer-readable medium described herein, the first transmission may be associated with a relatively earlier start time than the second transmission; and the first transmission at least partially overlaps in time with the second transmission.

In some examples of the method, apparatuses, and non-transitory computer-readable medium described herein, communication on the first radio link may be performed using a first radio frequency band; and communication on the second radio link may be performed using a second radio frequency band.

### BRIEF DESCRIPTION OF THE DRAWINGS

FIG. 1 shows an example of a wireless local area network (WLAN) that supports power control for concurrent transmission scenarios in multi-band operation in accordance with aspects of the present disclosure.

FIG. 2 shows an example of a signaling diagram that supports power control for concurrent transmission scenarios in multi-band operation in accordance with one or more aspects of the present disclosure

FIG. 3 shows an example of a communication timeline that supports power control for concurrent transmission scenarios in multi-band operation in accordance with one or more aspects of the present disclosure.

FIGS. 4 and 5 show block diagrams of devices that support power control for concurrent transmission scenarios in multi-band operation in accordance with one or more aspects of the present disclosure.

FIG. 6 shows a block diagram of a communications manager that supports power control for concurrent transmission scenarios in multi-band operation in accordance with one or more aspects of the present disclosure.

FIG. 7 shows a diagram of a system including an access point (AP) that supports power control for concurrent transmission scenarios in multi-band operation in accordance with one or more aspects of the present disclosure.

FIG. 8 shows a diagram of a system including a station (STA) that supports power control for concurrent transmission scenarios in multi-band operation in accordance with one or more aspects of the present disclosure.

FIG. 9 shows a flowchart illustrating methods that support power control for concurrent transmission scenarios in multi-band operation in accordance with one or more aspects of the present disclosure.

### DETAILED DESCRIPTION

In some wireless communications systems, a device may support concurrent or simultaneous transmissions across multiple frequency bands or radio links. For example, a device may perform a first transmission on a first frequency band or radio link and may simultaneously perform a second transmission on a second frequency band or radio link. Such a device may include any device capable of transmitting simultaneously across multiple frequency bands or radio links, and may sometimes be an example of a multi-chip device (e.g., a device that can operate multiple chipsets simultaneously, where each chipset may correspond to a different frequency band or radio link). In scenarios in which a device transmits across multiple frequency bands or radio links concurrently and at close-to-peak power, a total power consumption of the device may exceed a power budget of the device, which may cause an internal temperature of the device to increase. To mitigate the increase of the internal temperature of the device, the device may employ a power control mechanism associated with thermal throttling. Thermal throttling may involve cycling the device between on and off periods, where the device may be unable to transmit data during the off periods. As such, the device may experience throughput degradation and adverse impacts to latency-sensitive operations.

In some implementations of the present disclosure, a device may support an internal signaling mechanism between components that are associated with communication on different frequency bands or radio links. For example, the device may include a first arbitration block (e.g., a first processor block) that controls or manages communication on a first frequency band or radio link and a second arbitration block (e.g., a second processor block) that controls or manages communication on a second radio frequency band or radio link and, in some implementations, the device may support a signaling mechanism between the first arbitration block and the second arbitration block such that both arbitration blocks are aware of any ongoing transmissions, and their respective transmit powers, at the other arbitration block. Accordingly, both the first arbitration block and the second arbitration block may be aware of an up-to-date or current total transmit power of the device and, as such, may avoid setting a transmit power for an upcoming transmission that exceeds a power budget of the device. In some implementations, the first arbitration block or the second arbitration block may use a mapping table to determine which transmit power to select for an upcoming transmission that satisfies the power budget of the device based on a transmit power of an ongoing transmission at the other of the first arbitration block or the second arbitration block.

Particular implementations of the subject matter described in this disclosure can be implemented to realize one or more of the following potential advantages. For example, as a result of supporting an internal signaling mechanism according to which the first arbitration block and the second arbitration block may maintain an up-to-date view of transmit powers of ongoing transmissions from the device, the first arbitration block and the second arbitration block may proactively avoid exceeding a power budget associated with the device and, accordingly, reduce a likelihood for the device to overheat and enter a thermal throttling mode. As such, the device may experience greater throughput, higher data rates, greater spectral efficiency, and lower latency. Further, the described techniques may provide for a more graceful degradation of throughput as compared to the duty-cycling approach of thermal throttling, may be applicable to various platforms that include multiple transmit radios, and may enable original equipment manufacturers (OEMs) flexibility in designing device cost by opting for low-cost, low-power adapters (which may achieve satisfactory throughput and latency metrics in accordance with the described techniques).

Aspects of the disclosure are initially described in the context of a wireless communications system. Aspects of the disclosure are additionally illustrated by and described with reference to a signaling diagram and a communication timeline. Aspects of the disclosure are further illustrated by and described with reference to apparatus diagrams, system diagrams, and flowcharts that relate to power control for concurrent transmission scenarios in multi-band operation

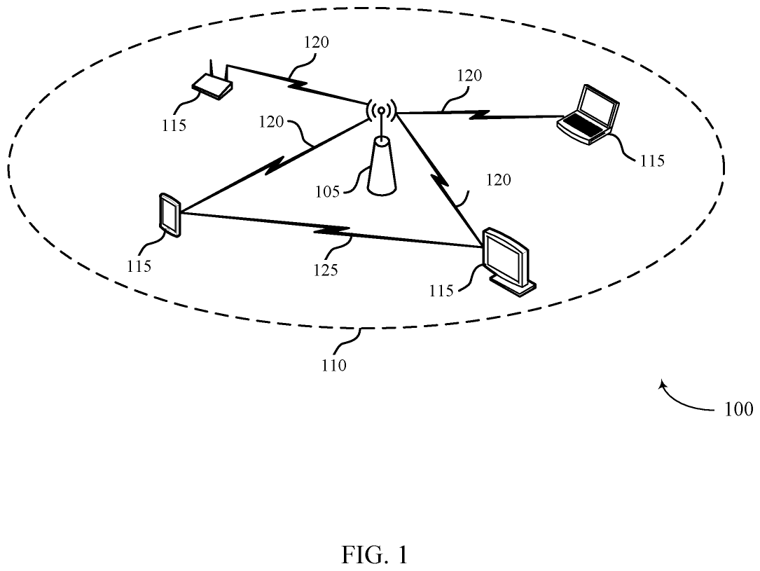

FIG. 1 shows a wireless local area network (WLAN) 100 that supports power control for concurrent transmission scenarios in multi-band operation in accordance with aspects of the present disclosure. The WLAN 100 (also known as a Wi-Fi network) may include an access point (AP) 105 and multiple associated stations (STAs) 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a BSS or an ESS. The various STAs 115 in the network are able to communicate with one another through the AP 105. Also shown is a coverage area 110 of the AP 105, which may represent a BSA of the WLAN 100. An extended network station (not shown) associated with the WLAN 100 may be connected to a wired or wireless distribution system that may allow multiple APs 105 to be connected in an ESS.

In some implementations, a device (e.g., a STA 115 or an AP 105) may support an internal signaling mechanism between components that are associated with communication on different frequency bands or radio links. For example, the device may include a first arbitration block (e.g., a first processor block) that controls or manages communication on a first frequency band or radio link and a second arbitration block (e.g., a second processor block) that controls or manages communication on a second radio frequency band or radio link and, in some implementations, the device may support a signaling mechanism between the first arbitration block and the second arbitration block such that both arbitration blocks are aware of any ongoing transmissions, and their respective transmit powers, at the other arbitration block. Accordingly, both the first arbitration block and the second arbitration block may be aware of an up-to-date or current total transmit power of the device and, as such, may avoid setting a transmit power for an upcoming transmission that exceeds a power budget of the device. In some implementations, the first arbitration block or the second arbitration block may use a mapping table to determine which transmit power to select for an upcoming transmission that satisfies the power budget of the device based on a transmit power of an ongoing transmission at the other of the first arbitration block or the second arbitration block.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of an RTS packet transmitted by a sending STA 115 (or AP 105) and a CTS packet transmitted by the receiving STA 115 (or AP 105). This may alert other devices within range of the sender and receiver not to transmit for the duration of the primary transmission. Thus, RTS/CTS may help mitigate a hidden node problem.

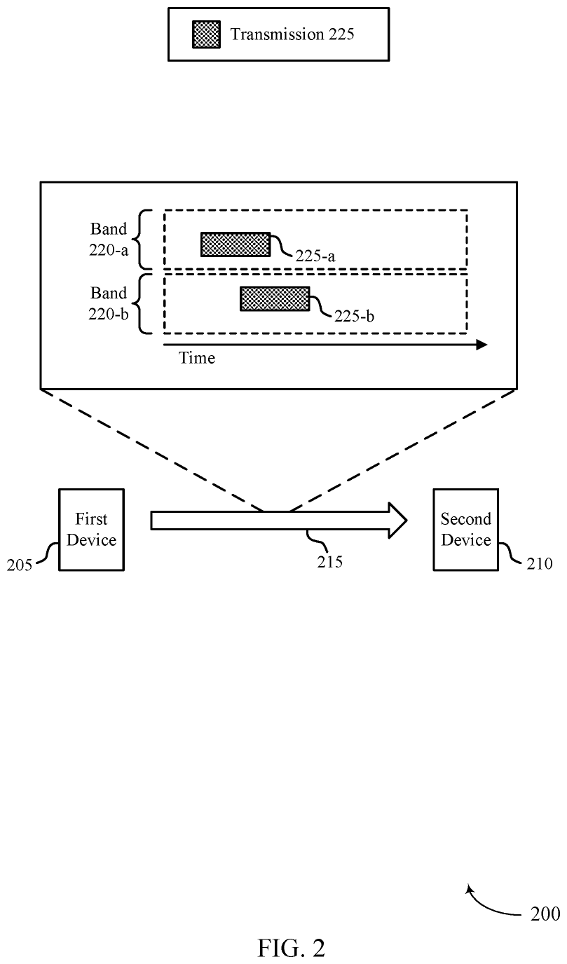

FIG. 2 shows an example of a signaling diagram 200 that supports power control for concurrent transmission scenarios in multi-band operation in accordance with one or more aspects of the present disclosure. The signaling diagram 200 may implement or be implemented to realize aspects of the WLAN 100. For example, the signaling diagram 200 illustrates communication between a first device 205 and a second device 210 via a communication link 215, and the first device 205 and the second device 210 may each be an example of a STA 115 or an AP 105 as illustrated by and described with reference to FIG. 1. In some implementations, the first device 205 may be an example of a device that is capable of concurrent transmissions across multiple frequency bands 220 and may support an internal signaling mechanism according to which transmit radios, transmit chains, processing blocks, or chipsets associated with the multiple frequency bands 220 can exchange information associated with transmit powers of ongoing transmissions at the first device 205.

In some aspects, for example, the first device 205 may be an example of a multi-chip platform and may support multiple chipsets. When two or more chipsets transmit concurrently at close-to-peak power, a total platform power consumption may exceed the power budget of an adapter of the first device 205. For example, as a chipset temperature increases due to increased transmit power consumption, leakage current at the first device 205 may increase (e.g., may increase exponentially), which may cause a further increase in overall power consumption. Additionally, or alternatively, the first device 205 may be an example of a low-tier or value-tier platform and, as such, an OEM may select to reduce device cost by opting for a lower-power adapter.

If an internal or chipset temperature of the first device 205 satisfies (e.g., exceeds) a threshold temperature, the first device 205 may employ a power control mechanism associated with thermal throttling to reduce the internal or chipset temperature, which may reduce the leakage current and overall power consumption of the first device 205. In some aspects, the first device 205 may rely on thermal throttling by duty cycling an active transmission time of the first device 205 (e.g., of the chipsets of the first device 205). For example, upon initiating thermal throttling, the first device 205 may cycle between on periods during which the first device 205 may transmit data and off periods during which the first device 205 is unable to transmit data (even if the first device 205 has data to transmit). As a result of such lack of data exchange during the transmission off periods, the first device 205 may experience potentially significant impacts on latency-sensitive applications and throughput degradation. In some aspects, the throughput degradation may be proportional to the duty cycle (e.g., a cycle length or periodicity of the duty cycle).

In some implementations, for concurrent transmissions 225, the first device 205 may adjust a transmit power (and, optionally, a modulation and coding scheme (MCS)) of an upcoming transmission to reduce a power amplifier power consumption such that a resulting platform power meets an adapter power budget. In some examples, the transmit power adjustments may be programmed in a static or semi-static manner (e.g., through offline profiling of the power amplifier power to temperature delta to leakage current to platform power). In some examples, such as examples in which the first device 205 is a multi-chip platform or device, the first device 205 may achieve the transmit power adjustments based on inter-chip communication. In such examples, the first device 205 may leverage hardware hooks to support such inter-chip communication and cooperation.

In the context of the signaling diagram 200, the first device 205 may be scheduled to perform a first transmission 225-a on a frequency band 220-a and a second transmission 225-b on a frequency band 220-b, where the first transmission 225-a has a relatively earlier starting time and at least partially overlaps in time with the second transmission 225-b. In some examples, a first arbitration block of the first device 205 may control or manage communication on the frequency band 220-a and a second arbitration block of the first device 205 may control or manage communication on the frequency band 220-b. The first arbitration block may select a first transmit power for the first transmission 225-a and, in some implementations, may transmit an indication of the first transmit power for the first transmission 225-a to the second arbitration block (and to any other arbitration blocks of the first device 205). As such, the second arbitration block may be aware of the first transmit power being used for the first transmission 225-a and may select a second transmit power for the second transmission 225-b based on or in view of the first transmit power.

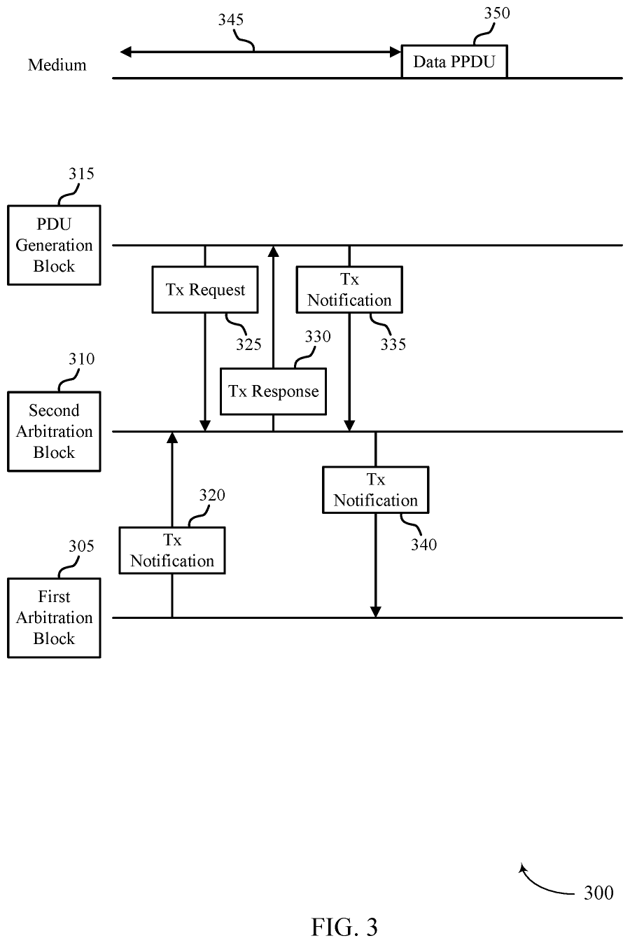

In some implementations, the second arbitration block may select the second transmit power for the second transmission 225-b based on determining a remaining available transmit power of the first device 205 based on the first transmit power and a transmit power constraint of the first device 205. Additionally, or alternatively, the second arbitration block may select the second transmit power for the second transmission 225-b based on the first transmit power and a mapping. For example, the first device 205 may support a mapping that is associated with multiple threshold transmit powers for the first transmission 225-a and each threshold transmit power of the multiple threshold transmit powers may correspond to a different transmit power for the second transmission 225-b in accordance with the mapping. Additional details relating to such transmit power adjustments for an upcoming transmission 225 based on transmit powers of one or more ongoing transmissions are illustrated by and described with reference to FIG. 3.

In some aspects, the first arbitration block may be associated with a first chipset of the first device 205 and the second arbitration block may be associated with a second chipset of the first device 205. In some other aspects, the first arbitration block and the second arbitration block may be associated with a same chipset (such that the first device 205 is a single-chip device) but may separately control or manage communication on different frequency bands 220 or different radio links. Further, a simultaneous full-buffer data exchange (e.g., downlink data exchange) between STAs 115 associated with a first operator and an AP 105 associated with a second operator on all radios may result in a reference signal strength indicator (RSSI), an MCS, and physical layer protocol data unit (PPDU) reception start and end time on each radio that are unique or specially associated with the signaling mechanism and corresponding transmit power adjustments described herein.

Further, although described herein in the context of two bands 220 (such as the band 220-a and the band 220-b) or two chipsets, the first device 205 may support communications on three or more bands 220 or may support communications using three or more chipsets. In implementations in which the device 205 supports three or more bands 220, for example, an arbitration block of the device 205 may select a first transmit power for a first transmission 225 and, in some implementations, may transmit an indication of the first transmit power for the first transmission 225 to multiple other arbitration blocks of the device 205. For example, the arbitration block may transmit the indication of the first transmit power to a second arbitration block associated with a second band 220 or second chipset, a third arbitration block associated with a third band 220 or a third chipset, and so on for each band 220 or chipset supported by the first device 205. Likewise, an arbitration block of the first device 205 may receive indications of transmit powers from multiple other arbitration blocks of the first device 205. For example, an arbitration block of the first device 205 may receive one or more transmit power indications from second arbitration block associated with a second band 220 or a second chipset, a third arbitration block associated with a third band 220 or a third chipset, and so on for each band 220 or chipset supported by the first device 205. In such implementations, an arbitration block may use indicated transmit powers from multiple different other arbitration blocks of the first device 205 (e.g., a summation of multiple different transmit powers) to select a transmit power for an upcoming transmission.

In accordance with the described techniques, the first device 205 may support a relatively fast or just-in-time decision making procedure between two radios to keep the total transmit power under a certain constraint. In accordance with the described techniques, the first device 205 may obtain time averaged SAR between WAN and Wi-Fi as well and the first device 205 may extend the techniques to a multi-chip multi-link operation (MLO) architecture. In some implementations, the first device 205 may utilize a hardware (e.g., chip2chip) exchange of ongoing transmit power of one radio so that the other radio can decide if it has enough transmit power headroom to make a transmission (e.g., an async-multi-link multi-radio (MLMR) transmission) without exceeding the thermal budget. The first device 205 may support options to abort the new transmission or the ongoing one. Accordingly, the first device 205 may experience lower latency and a more graceful degradation of throughput as compared to a duty-cycling approach of thermal throttling.

FIG. 3 shows an example of a communication timeline 300 that supports power control for concurrent transmission scenarios in multi-band operation in accordance with one or more aspects of the present disclosure. The communication timeline 300 may implement or be implemented to realize aspects of the WLAN 100 or the signaling diagram 200. For example, the communication timeline 300 illustrates communication between various components of a device (such as the first device 205) and the device may leverage the illustrated inter-component signaling mechanism to adjust a transmit power for an upcoming transmission based on a transmit power being used for a concurrent transmission on a different frequency band or radio link or from a different chipset. For example, the device may support MLO via either a single chipset or with multiple chipsets.

The device may include at least a first arbitration block 305 associated with a first radio link (e.g., a first frequency band or a first chipset of the device), a second arbitration block 310 associated with a second radio link (e.g., a second frequency band or a second chipset of the device), and a protocol data unit (PDU) generation block 315 associated with the second radio link. In some implementations, the first arbitration block 305, the second arbitration block 310, and the PDU generation block 315 may support a signaling mechanism according to which the second arbitration block 310 maintains awareness or knowledge of transmit powers of transmissions from the device on the first radio link (and on any other radio links supported by the device) and uses the awareness or knowledge to adjust a transmit power for an upcoming transmission on the second radio link. The PDU generation block 315 may be understood as a block of the device that may prepare a PPDU for transmission (e.g., in accordance with a specific transmit power and a specific MCS).

At 320, for example, the second arbitration block 310 may receive, from the first arbitration block 305, a transmission notification including an indication of a first transmit power for a first transmission on the first radio link. In other words, the first arbitration block 305 may configure the first transmission from the device on the first radio link with the first transmit power and, in accordance with configuring the first transmission on the first radio link with the first transmit power, may inform the second arbitration block 310 of the first transmit power. The first arbitration block 305 may additionally inform the second arbitration block 310 with other information associated with the first transmission, such as a start time and a duration of the first transmission. For example, when the device starts transmitting on the first radio link, a PDU generation block associated with the first radio link may communicate the first transmit power and a PPDU duration to the PDU generation block 315 associated with the second radio link via the first arbitration block 305 and the second arbitration block 310 (e.g., via an interface between the first arbitration block 305 and the second arbitration block 310).

As such, the second arbitration block 310 may be aware of or otherwise store information associated with the first transmit power of the first transmission on the first radio link (even though the second arbitration block 310 may exclusively control or manage communication on the second radio link). In some aspects, the PDU generation block 315 may further communicate with a hardware shared channel link associated with the second radio link and, prior to 325, the hardware shared channel link may transmit one or more setup messages to the PDU generation block 315.

At 325, the second arbitration block 310 may receive, from the PDU generation block 315, a transmission request including an indication of a request for a default transmit power for a second transmission on the second radio link. For example, the device (e.g., via software or firmware) may include a transmit power for a scheduled packet in a scheduling command for each radio link, where such a transmit power for a scheduled packet may be referred to or understood as a default transmit power. In some aspects, the PDU generation block 315 may include a set of one or more parameters in the transmission request, including an indication of the default transmit power for, a duration of the second transmission, or a request reason. In accordance with receiving the transmission request, the second arbitration block 310 may determine a second transmit power for the second transmission, where the second transmit power may be equal to the requested default transmit power or less than the requested default transmit power depending on the first transmit power and a transmit power constraint of the first device.

In some implementations, for example, the second arbitration block 310 may determine a remaining available transmit power of the device based on the first transmit power for the first transmission and the transmit power constraint of the device. In other words, the second arbitration block 310 may subtract the first transmit power from an upper limit or maximum transmit power that the device is capable of to determine the remaining available transmit power. The second arbitration block 310 may compare the requested default transmit power to the remaining available transmit power and may select the second transmit power based on the comparison. In such implementations, the second transmit power may be equal to the default transmit power if the remaining available transmit power is greater than the default transmit power and the second transmit power may be less than the default transmit power if the remaining available transmit power is less than the default transmit power.

Additionally, or alternatively, the second arbitration block 310 may select the second transmit power for the second transmission based on the first transmit power and a mapping (which may be signaled to the device or pre-configured at the device). In some examples, the mapping may be associated with various threshold transmit powers for the first transmission and each threshold transmit power of the various threshold transmit powers may correspond to a different transmit power for the second transmission. In other words, the mapping may indicate a correspondence between a first set of potential transmit powers for an ongoing transmission (e.g., the first transmission) and a second set of potential transmit powers for an upcoming transmission (e.g., the second transmission) that at least partially overlaps in time with the ongoing transmission. As such, a transmit power of the first set of potential transmit powers and a corresponding transmit power of the second set of potential transmit powers may satisfy the transmit power constraint of the device based on the mapping. For example, a transmit power of the first set of potential transmit powers and a corresponding transmit power of the second set of potential transmit powers may add up to be less than or equal to an upper limit or maximum transmit power of the device.

An example mapping associated with the various threshold transmit powers and which transmit power the second arbitration block 310 may select as the second transmit is illustrated by Table 1, shown below. As illustrated by Table 1, the second arbitration block 310 may use the correspondence indicated by the mapping to select the second transmit power for the second transmission (e.g., a second WLAN maximum transmit power on the second radio link) based on the first transmit power for the first transmission (e.g., a first WLAN transmit power on the first radio link).

TABLE 1
Inter-Radio Link Tx Power Mapping

| First WLAN Tx Power | Second WLAN Max Tx |
|---|---|
| on First Radio Link | Power on Second Radio Link |
| (dBm) | (dBm) |
| >=Threshold | First Value |
| Threshold - 1 | Second Value |
| Threshold - 2 | ″ |
| . . . | . . . |
| Threshold - 14 | ″ |
| <=Threshold - 15 | ″ |

For example, if the first transmit power is greater than a baseline “threshold” value and less than a “threshold −1” value, the second arbitration block 310 may select a first value for the second transmit power. For further example, if the first transmit power is greater than the “threshold −1” value and less than a “threshold −2” value, the second arbitration block 310 may select a second value for the second transmit power. In some aspects, the first value, the second value, and so on may be software programmed values (e.g., software programmed lookup values) stored at the device. In some aspects, the device may program or determine (e.g., via software or firmware) a transmit power lookup table (LUT) in a medium access control (MAC) hardware of each chip of the device in a semi-static manner and the mapping may reference the transmit power LUT. As such, if the device attempts to initiate the second transmission on the second radio link while the device is already transmitting on the first radio link, the second arbitration block 310 of the second radio link may determine an upper limit or maximum allowed transmit power for the second transmission on the second radio link based on the LUT and given the ongoing transmit power on the first radio link.

At 330, the second arbitration block 310 may transmit, to the PDU generation block 315, a transmission response including an indication of the second transmit power for the second transmission on the second radio link based on the request for the default transmit power and the indication of the first transmit power. The transmission response may include an indication of a final transmit power (e.g., the second transmit power) and a change reason. For example, the second arbitration block 310 may include an indication of the reason for why the second arbitration block 310 indicates the second transmit power in response to receiving the request for the default transmit power (if the second transmit power is different from the default transmit power).

In some implementations, the second arbitration block 310 or the PDU generation block 315, or both, may determine whether a resulting transmit power reduction satisfies a threshold margin and, if so, the second arbitration block 310 or the PDU generation block 315, or both, may determine to abort the upcoming transmission (e.g., the second transmission) on the second radio link. For example, one or more component of the device may determine that a likelihood for successful reception of the second transmission may fall below a threshold likelihood as a result of the second transmit power (e.g., if a difference between the default transmit power and the second transmit power is greater than the threshold margin) and may determine to abort the transmission accordingly.

In some aspects, such a threshold margin may be referred to herein a threshold transmit power delta associated with aborting the second transmission, as the second arbitration block 310 or the PDU generation block 315 may compare a difference between the default transmit power and the second transmit power (e.g., a resulting transmit power reduction) to the threshold margin. Accordingly, in some examples, the device (e.g., in accordance with a decision by the second arbitration block 310 or the PDU generation block 315) may drop the second transmission based on a transmit power delta between the default transmit power and the second transmit power satisfying a threshold transmit power delta associated with aborting the second transmission (e.g., the threshold margin). The threshold margin may be programmable (e.g., via software or firmware) by the device. In some aspects, the threshold margin may be programmed in a semi-static manner.

In some implementations, the device may refrain from dropping the second transmission if the second transmission is associated with a latency-critical or a latency-sensitive client (e.g., if the second transmission is a latency-sensitive transmission). In such implementations, the device may indicate, via software or firmware in a scheduling command associated with the second transmission, that the second transmission may not be aborted. In some aspects, the device may indicate or detect such a prohibition on dropping the second transmission via a 1-bit information field or flag in the scheduling command associated with the second transmission. As such, the device may obtain (e.g., from software or firmware of the device) the scheduling command associated with the second transmission, detect whether the scheduling command indicates that the second transmission is a latency-sensitive transmission, and either allow or prohibit dropping of the second transmission (e.g., in view of the threshold transmit power reduction margin) based on whether the second transmission is a latency-sensitive transmission.

In some implementations, the device may prioritize the second transmission over the first transmission and, if dropping is to be employed to avoid exceeding a power constraint of the device, the device may drop a portion of the first transmission that overlaps in time with the second transmission. For example, if the transmit power delta between the default transmit power and the second transmit power satisfies a threshold transmit power (e.g., the threshold margin, or a threshold transmit power sometimes associated with dropping the second transmission) and if the second transmission has a higher priority than the first transmission, the device (e.g., via the first arbitration block 305) may drop a portion of the first transmission that overlaps in time with the second transmission. Accordingly, the device may perform the second transmission in accordance with the default transmit power (as, because of the dropping of the portion of the first transmission, there may no longer be concurrent transmission at the device for the second transmission).

Additionally, or alternatively, the scheduling command associated with the second transmission may indicate a mapping between the transmit power delta between the default transmit power and the second transmit power and an MCS index. For example, the device may indicate or detect, in the scheduling command, a transmit power delta for the second transmission to MCS delta mapping and the device (e.g., the second arbitration block 310 or the PDU generation block 315) may use the mapping if a reduced transmit power (relative to the default transmit power) is used for the second transmission.

Accordingly, if a reduced transmit power is used for the second transmission, the device (e.g., via the second arbitration block 310 or the PDU generation block 315) may select an MCS for the second transmission based on the transmit power delta and the mapping and may perform the second transmission in accordance with the second transmit power and the selected MCS. In an example, if the delta transmit power between the default transmit power and the second transmit power is less than or equal to 3 dB, the device may use an MCS −1 (e.g., an original or initially configured or indicated MCS index minus one). For further example, if the delta transmit power is greater than 3 dB and less than or equal to 6 dB, the device may use an MCS −2 (e.g., an original or initially configured or indicated MCS index minus two). For further example, if the transmit power delta is greater than 6 dB, the device may use MCS 0 and NSS1. In some implementations, the device may use MCS 0 and NSS1 whenever a reduced transmit power is used (e.g., whenever the second transmit power is less than the default transmit power). In such implementations, the scheduling command may include a 1-bit information field or flag indicating that MCS 0 and NSS1 are to be used for the second transmission if the second transmit power is less than the default transmit power.

At 335, the second arbitration block 310 may receive, from the PDU generation block 315, a transmission notification including an indication, acknowledgment, or confirmation of the final transmit power (e.g., the second transmit power) and an indication of the duration of the second transmission. In some aspects, depending on reception of information from an AP 105, the PDU generation block 315 may lack any calculated information associated with the transmission time of the second transmission. In such aspects, the PDU generation block 315 may exclude an indication of the duration of the second transmission from the transmission notification or may set a corresponding bit field to a null value. In some aspects, the transmission notification may further include a reason associated with the second transmission or the power reduction for the second transmission or software meta data.

At 340, the second arbitration block 310 may transmit, to the first arbitration block 305, a transmission notification including an indication of the second transmit power for the second transmission. In some examples, the second arbitration block 310 may further include an indication of the duration of the second transmission in the transmission notification. In some aspects, the transmission notification may further include a reason associated with the second transmission or the power reduction for the second transmission or software meta data.

As such, the first arbitration block 305 may be aware of a time period during which the device is using the second transmit power on the second radio link and may manage, control, or set transmit powers for transmissions on the first radio link in view of the time period during which the device is using the second transmit power on the second radio link. In some aspects, the operations spanning from 320 to 340 may be associated with a pre-transmission duration 345 and the device may transmit a data PPDU 350 upon completion of the operations spanning from 320 to 340. The data PPDU 350 may be an example of the second transmission as described herein.

In some aspects, the first arbitration block 305, the second arbitration block 310, and the PDU generation block 315 may perform such a signaling mechanism multiple times or continuously (such that the first arbitration block 305 and the second arbitration block 310 may continuously update each other on current transmit powers used on their respective radio links, frequency bands, or chipsets. Additionally, or alternatively, the operations spanning from 320 to 340 may be associated with a pre-backoff duration and the device may perform a clear-to-send (CTS)-to-self (CTS2SELF) message upon completion of the operations spanning from 320 to 340. In such scenarios, the device may repeat one or more of the operations from 320 to 340 during a short interframe space (SIFS) and may transmit the data PPDU 350 after the SIFS. Such a repetition of one or more of the operations from 320 to 340 may refer to a refresh between the first arbitration block 305 and the second arbitration block 310 on what transmit powers the device may be using across different links, different frequency bands, or different chipsets such that the device is able to perform the second transmission (e.g., transmit the data PPDU 350) using a transmit power that is based on most up-to-date (and not stale) transmit power information from across the different links, frequency bands, or chipsets that the device may support. An MLO BA session may follow the data PPDU 350.

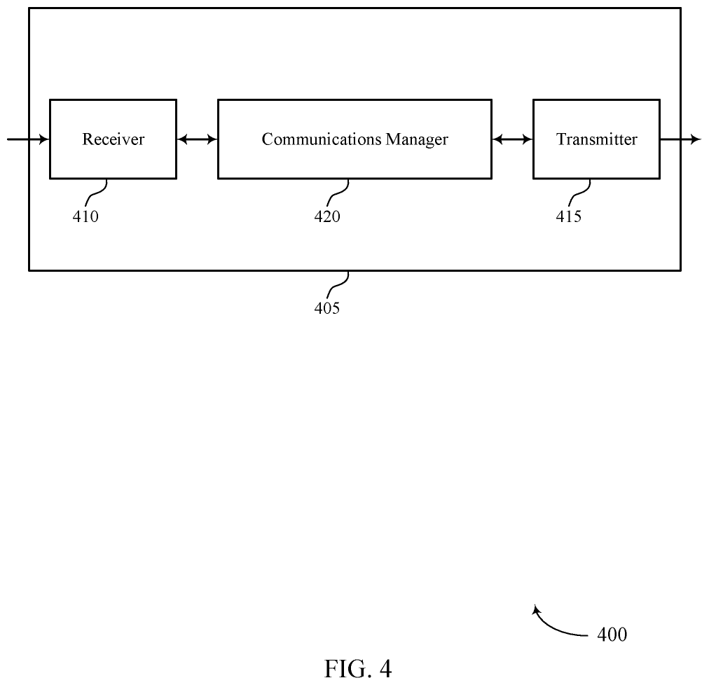

FIG. 4 shows a block diagram 400 of a device 405 that supports power control for concurrent transmission scenarios in multi-band operation in accordance with one or more aspects of the present disclosure. The device 405 may be an example of aspects of an AP or an STA as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to power control for concurrent transmission scenarios in multi-band operation). Information may be passed on to other components of the device 405. The receiver 410 may utilize a single antenna or a set of multiple antennas.

The transmitter 415 may provide a means for transmitting signals generated by other components of the device 405. The transmitter 415 may utilize a single antenna or a set of multiple antennas.

The communications manager 420, the receiver 410, the transmitter 415, or various combinations thereof or various components thereof may be examples of means for performing various aspects of power control for concurrent transmission scenarios in multi-band operation as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a device in accordance with examples as disclosed herein. For example, the communications manager 420 may be configured as or otherwise support a means for receiving, from a first arbitration block associated with a first radio link and at a second arbitration block associated with a second radio link, an indication of a first transmit power for a first transmission on the first radio link. The communications manager 420 may be configured as or otherwise support a means for receiving, from a PDU generation block associated with the second radio link and at the second arbitration block, a request for a default transmit power for a second transmission on the second radio link. The communications manager 420 may be configured as or otherwise support a means for transmitting, to the PDU generation block from the second arbitration block, an indication of a second transmit power for the second transmission on the second radio link based on the request for the default transmit power and the indication of the first transmit power for the first transmission on the first radio link. The communications manager 420 may be configured as or otherwise support a means for transmitting, to the first arbitration block from the second arbitration block, an indication of the second transmit power for the second transmission on the second radio link.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for reduced processing, reduced power consumption, and more efficient utilization of communication resources.

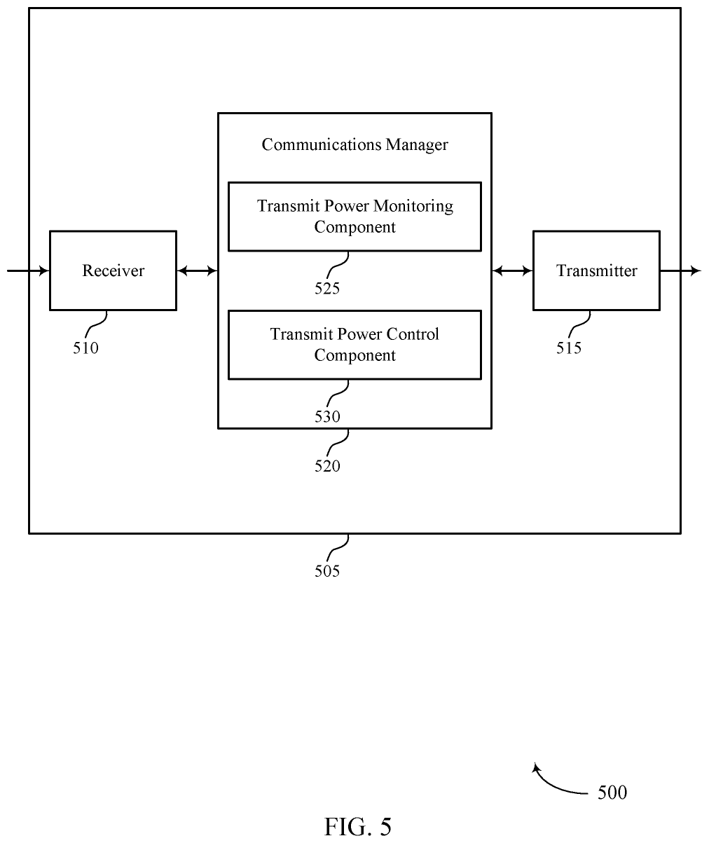

FIG. 5 shows a block diagram 500 of a device 505 that supports power control for concurrent transmission scenarios in multi-band operation in accordance with one or more aspects of the present disclosure. The device 505 may be an example of aspects of a device 405, an AP 105, or an STA 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to power control for concurrent transmission scenarios in multi-band operation). Information may be passed on to other components of the device 505. The receiver 510 may utilize a single antenna or a set of multiple antennas.

The transmitter 515 may provide a means for transmitting signals generated by other components of the device 505. The transmitter 515 may utilize a single antenna or a set of multiple antennas.

The device 505, or various components thereof, may be an example of means for performing various aspects of power control for concurrent transmission scenarios in multi-band operation as described herein. For example, the communications manager 520 may include a transmit power monitoring component 525 a transmit power control component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a device in accordance with examples as disclosed herein. The transmit power monitoring component 525 may be configured as or otherwise support a means for receiving, from a first arbitration block associated with a first radio link and at a second arbitration block associated with a second radio link, an indication of a first transmit power for a first transmission on the first radio link. The transmit power control component 530 may be configured as or otherwise support a means for receiving, from a PDU generation block associated with the second radio link and at the second arbitration block, a request for a default transmit power for a second transmission on the second radio link. The transmit power control component 530 may be configured as or otherwise support a means for transmitting, to the PDU generation block from the second arbitration block, an indication of a second transmit power for the second transmission on the second radio link based on the request for the default transmit power and the indication of the first transmit power for the first transmission on the first radio link. The transmit power monitoring component 525 may be configured as or otherwise support a means for transmitting, to the first arbitration block from the second arbitration block, an indication of the second transmit power for the second transmission on the second radio link.

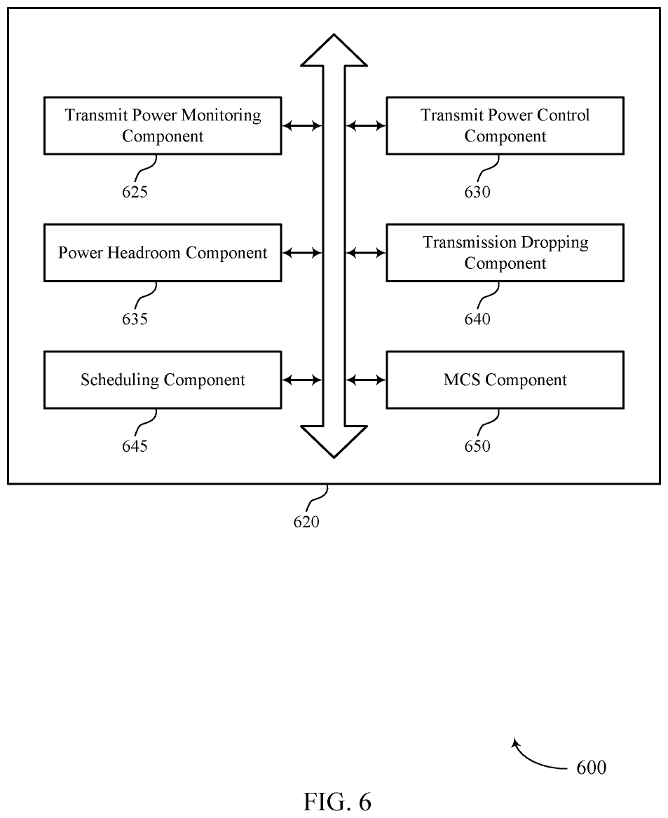

FIG. 6 shows a block diagram 600 of a communications manager 620 that supports power control for concurrent transmission scenarios in multi-band operation in accordance with one or more aspects of the present disclosure. The communications manager 620 may be an example of aspects of a communications manager 420, a communications manager 520, or both, as described herein. The communications manager 620, or various components thereof, may be an example of means for performing various aspects of power control for concurrent transmission scenarios in multi-band operation as described herein. For example, the communications manager 620 may include a transmit power monitoring component 625, a transmit power control component 630, a power headroom component 635, a transmission dropping component 640, a scheduling component 645, an MCS component 650, or any combination thereof. Each of these components may communicate, directly or indirectly, with one another (e.g., via one or more buses).

The communications manager 620 may support wireless communication at a device in accordance with examples as disclosed herein. The transmit power monitoring component 625 may be configured as or otherwise support a means for receiving, from a first arbitration block associated with a first radio link and at a second arbitration block associated with a second radio link, an indication of a first transmit power for a first transmission on the first radio link. The transmit power control component 630 may be configured as or otherwise support a means for receiving, from a PDU generation block associated with the second radio link and at the second arbitration block, a request for a default transmit power for a second transmission on the second radio link. In some examples, the transmit power control component 630 may be configured as or otherwise support a means for transmitting, to the PDU generation block from the second arbitration block, an indication of a second transmit power for the second transmission on the second radio link based on the request for the default transmit power and the indication of the first transmit power for the first transmission on the first radio link. In some examples, the transmit power monitoring component 625 may be configured as or otherwise support a means for transmitting, to the first arbitration block from the second arbitration block, an indication of the second transmit power for the second transmission on the second radio link.

In some examples, the power headroom component 635 may be configured as or otherwise support a means for determining a remaining available transmit power of the device based on the first transmit power for the first transmission and a transmit power constraint of the device. In some examples, the power headroom component 635 may be configured as or otherwise support a means for comparing the default transmit power to the remaining available transmit power. In some examples, the transmit power control component 630 may be configured as or otherwise support a means for selecting the second transmit power for the second transmission based on comparing the default transmit power to the remaining available transmit power, where transmitting the indication of the second transmit power to the PDU generation block is based on selecting the second transmit power.

In some examples, the second transmit power is equal to the default transmit power if the remaining available transmit power is greater than the default transmit power; or the second transmit power is less than the default transmit power if the remaining available transmit power is less than the default transmit power.

In some examples, the transmit power control component 630 may be configured as or otherwise support a means for selecting the second transmit power for the second transmission based on the first transmit power for the first transmission and a mapping, where transmitting the indication of the second transmit power to the PDU generation block is based on selecting the second transmit power.

In some examples, the mapping is associated with a set of multiple threshold transmit powers for the first transmission on the first radio link; and each threshold transmit power of the set of multiple threshold transmit powers for the first transmission on the first radio link corresponds to a different transmit power for the second transmission on the second radio link in accordance with the mapping.

In some examples, the mapping indicates a correspondence between a first set of potential transmit powers for an ongoing transmission on the first radio link and a second set of potential transmit powers for an upcoming transmission on the second radio link that at least partially overlaps in time with the ongoing transmission on the first radio link; and a transmit power of the first set of potential transmit powers and a corresponding transmit power of the second set of potential transmit powers satisfy a transmit power constraint of the device based on the mapping.

In some examples, the transmission dropping component 640 may be configured as or otherwise support a means for dropping the second transmission based on a transmit power delta between the default transmit power and the second transmit power satisfying a threshold transmit power delta associated with aborting the second transmission.

In some examples, the scheduling component 645 may be configured as or otherwise support a means for obtaining a scheduling command associated with the second transmission that indicates the second transmission is a latency-sensitive transmission. In some examples, the transmit power control component 630 may be configured as or otherwise support a means for performing the second transmission in accordance with the second transmit power regardless of whether a transmit power delta between the default transmit power and the second transmit power satisfies a threshold transmit power delta associated with aborting the second transmission based on the second transmission being the latency-sensitive transmission.

In some examples, the scheduling component 645 may be configured as or otherwise support a means for obtaining a scheduling command associated with the second transmission that indicates a mapping between a transmit power delta between the default transmit power and the second transmit power and a modulation and coding scheme index. In some examples, the MCS component 650 may be configured as or otherwise support a means for selecting a modulation and coding scheme for the second transmission based on the transmit power delta and the mapping. In some examples, the transmit power control component 630 may be configured as or otherwise support a means for performing the second transmission in accordance with the second transmit power and the modulation and coding scheme.

In some examples, the transmission dropping component 640 may be configured as or otherwise support a means for dropping a portion of the first transmission that overlaps in time with the second transmission based on the second transmission being associated with a higher priority than the first transmission and based on a transmit power delta between the default transmit power and the second transmit power. In some examples, the transmit power control component 630 may be configured as or otherwise support a means for performing the second transmission in accordance with the default transmit power based on dropping the portion of the first transmission that overlaps in time with the second transmission.

In some examples, the first transmission is associated with a relatively earlier start time than the second transmission; and the first transmission at least partially overlaps in time with the second transmission.

In some examples, communication on the first radio link is performed using a first radio frequency band; and communication on the second radio link is performed using a second radio frequency band.

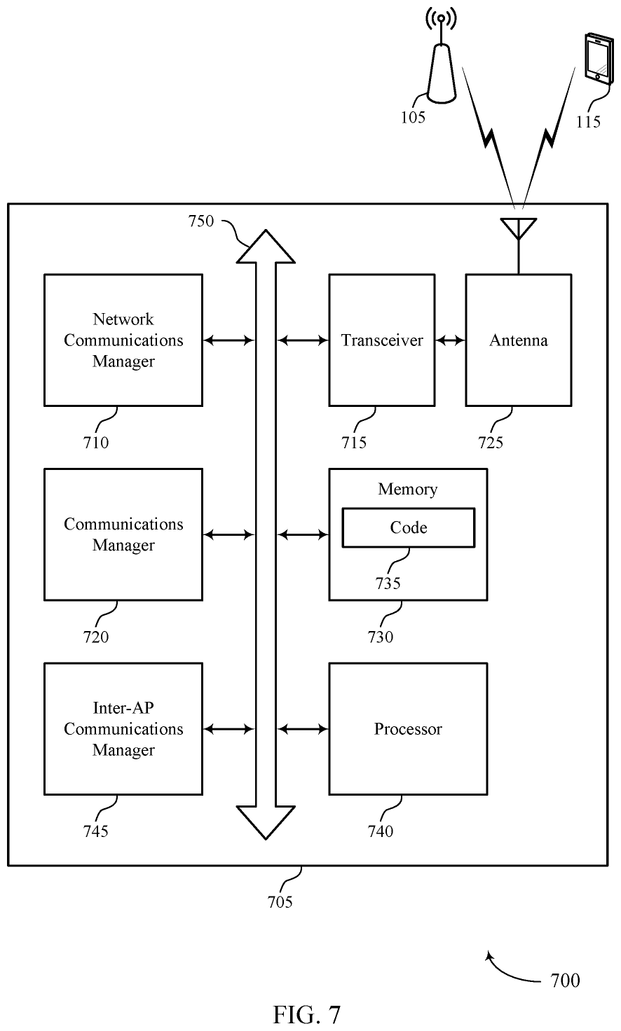

FIG. 7 shows a diagram of a system 700 including a device 705 that supports power control for concurrent transmission scenarios in multi-band operation in accordance with one or more aspects of the present disclosure. The device 705 may be an example of or include the components of a device 405, a device 505, or an AP as described herein. The device 705 may include components for bi-directional voice and data communications including components for transmitting and receiving communications, such as a communications manager 720, a network communications manager 710, a transceiver 715, an antenna 725, a memory 730, code 735, a processor 740, and an inter-AP communications manager 745. These components may be in electronic communication or otherwise coupled (e.g., operatively, communicatively, functionally, electronically, electrically) via one or more buses (e.g., a bus 750).

The network communications manager 710 may manage communications with a core network (e.g., via one or more wired backhaul links). For example, the network communications manager 710 may manage the transfer of data communications for client devices, such as one or more STAs 115.

In some cases, the device 705 may include a single antenna 725. However, in some other cases the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets and provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include RAM and ROM. The memory 730 may store computer-readable, computer-executable code 735 including instructions that, when executed by the processor 740, cause the device 705 to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting power control for concurrent transmission scenarios in multi-band operation). For example, the device 705 or a component of the device 705 may include a processor 740 and memory 730 coupled with or to the processor 740, the processor 740 and memory 730 configured to perform various functions described herein.

The inter-station communications manager 745 may manage communications with other APs 105, and may include a controller or scheduler for controlling communications with STAs 115 in cooperation with other APs 105. For example, the inter-station communications manager 745 may coordinate scheduling for transmissions to APs 105 for various interference mitigation techniques such as beamforming or joint transmission. In some examples, the inter-station communications manager 745 may provide an X2 interface within an LTE/LTE-A wireless communication network technology to provide communication between APs 105.

The communications manager 720 may support wireless communication at a device in accordance with examples as disclosed herein. For example, the communications manager 720 may be configured as or otherwise support a means for receiving, from a first arbitration block associated with a first radio link and at a second arbitration block associated with a second radio link, an indication of a first transmit power for a first transmission on the first radio link. The communications manager 720 may be configured as or otherwise support a means for receiving, from a PDU generation block associated with the second radio link and at the second arbitration block, a request for a default transmit power for a second transmission on the second radio link. The communications manager 720 may be configured as or otherwise support a means for transmitting, to the PDU generation block from the second arbitration block, an indication of a second transmit power for the second transmission on the second radio link based on the request for the default transmit power and the indication of the first transmit power for the first transmission on the first radio link. The communications manager 720 may be configured as or otherwise support a means for transmitting, to the first arbitration block from the second arbitration block, an indication of the second transmit power for the second transmission on the second radio link.

By including or configuring the communications manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, and improved utilization of processing capability.

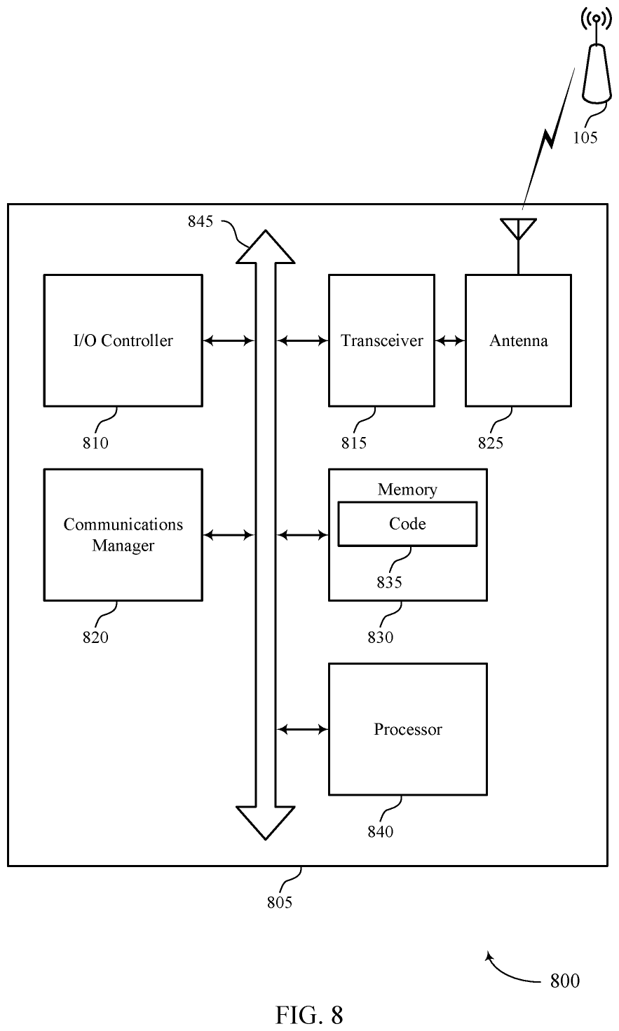

FIG. 8 shows a diagram of a system 800 including a device 805 that supports power control for concurrent transmission scenarios in multi-band operation in accordance with one or more aspects of the present disclosure. The device 805 may be an example of or include the components of a device 405, a device 505, or an STA as described herein. The device 805 may include components for bi-directional voice and data communications including components for transmitting and receiving communications, such as a communications manager 820, an I/O controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In some other cases, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets and provide the modulated packets to one or more antennas 825 for transmission, and to demodulate packets received from the one or more antennas 825. The transceiver 815, or the transceiver 815 and one or more antennas 825, may be an example of a transmitter 415, a transmitter 515, a receiver 410, a receiver 510, or any combination thereof or component thereof, as described herein.

The memory 830 may include RAM and ROM. The memory 830 may store computer-readable, computer-executable code 835 including instructions that, when executed by the processor 840, cause the device 805 to perform various functions described herein. In some cases, the memory 830 may contain, among other things, a BIOS which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting power control for concurrent transmission scenarios in multi-band operation). For example, the device 805 or a component of the device 805 may include a processor 840 and memory 830 coupled with or to the processor 840, the processor 840 and memory 830 configured to perform various functions described herein.

The communications manager 820 may support wireless communication at a device in accordance with examples as disclosed herein. For example, the communications manager 820 may be configured as or otherwise support a means for receiving, from a first arbitration block associated with a first radio link and at a second arbitration block associated with a second radio link, an indication of a first transmit power for a first transmission on the first radio link. The communications manager 820 may be configured as or otherwise support a means for receiving, from a PDU generation block associated with the second radio link and at the second arbitration block, a request for a default transmit power for a second transmission on the second radio link. The communications manager 820 may be configured as or otherwise support a means for transmitting, to the PDU generation block from the second arbitration block, an indication of a second transmit power for the second transmission on the second radio link based on the request for the default transmit power and the indication of the first transmit power for the first transmission on the first radio link. The communications manager 820 may be configured as or otherwise support a means for transmitting, to the first arbitration block from the second arbitration block, an indication of the second transmit power for the second transmission on the second radio link.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, and improved utilization of processing capability.

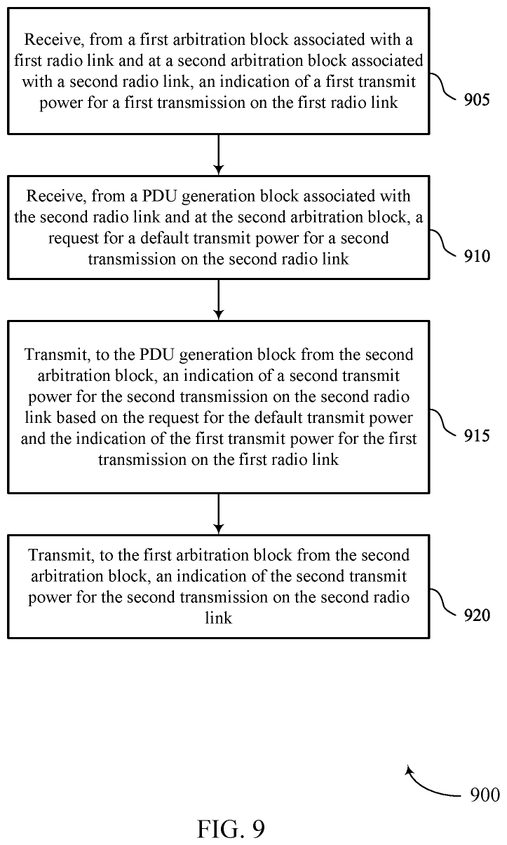

FIG. 9 shows a flowchart illustrating a method 900 that supports power control for concurrent transmission scenarios in multi-band operation in accordance with one or more aspects of the present disclosure. The operations of the method 900 may be implemented by an AP or an STA or its components as described herein. For example, the operations of the method 900 may be performed by an AP or an STA as described with reference to FIGS. 1 through 8. In some examples, an AP or an STA may execute a set of instructions to control the functional elements of the AP or the STA to perform the described functions. Additionally, or alternatively, the AP or the STA may perform aspects of the described functions using special-purpose hardware.

At 905, the method may include receiving, from a first arbitration block associated with a first radio link and at a second arbitration block associated with a second radio link, an indication of a first transmit power for a first transmission on the first radio link. The operations of 905 may be performed in accordance with examples as disclosed herein. In some examples, aspects of the operations of 905 may be performed by a transmit power monitoring component 625 as described with reference to FIG. 6.

At 910, the method may include receiving, from a PDU generation block associated with the second radio link and at the second arbitration block, a request for a default transmit power for a second transmission on the second radio link. The operations of 910 may be performed in accordance with examples as disclosed herein. In some examples, aspects of the operations of 910 may be performed by a transmit power control component 630 as described with reference to FIG. 6.

At 915, the method may include transmitting, to the PDU generation block from the second arbitration block, an indication of a second transmit power for the second transmission on the second radio link based on the request for the default transmit power and the indication of the first transmit power for the first transmission on the first radio link. The operations of 915 may be performed in accordance with examples as disclosed herein. In some examples, aspects of the operations of 915 may be performed by a transmit power control component 630 as described with reference to FIG. 6.

At 920, the method may include transmitting, to the first arbitration block from the second arbitration block, an indication of the second transmit power for the second transmission on the second radio link. The operations of 920 may be performed in accordance with examples as disclosed herein. In some examples, aspects of the operations of 920 may be performed by a transmit power monitoring component 625 as described with reference to FIG. 6.

The following provides an overview of aspects of the present disclosure:

Aspect 1: A method for wireless communication at a device, comprising: receiving, from a first arbitration block associated with a first radio link and at a second arbitration block associated with a second radio link, an indication of a first transmit power for a first transmission on the first radio link; receiving, from a PDU generation block associated with the second radio link and at the second arbitration block, a request for a default transmit power for a second transmission on the second radio link; transmitting, to the PDU generation block from the second arbitration block, an indication of a second transmit power for the second transmission on the second radio link based at least in part on the request for the default transmit power and the indication of the first transmit power for the first transmission on the first radio link; and transmitting, to the first arbitration block from the second arbitration block, an indication of the second transmit power for the second transmission on the second radio link.

Aspect 2: The method of aspect 1, further comprising: determining a remaining available transmit power of the device based at least in part on the first transmit power for the first transmission and a transmit power constraint of the device; comparing the default transmit power to the remaining available transmit power; and selecting the second transmit power for the second transmission based at least in part on comparing the default transmit power to the remaining available transmit power, wherein transmitting the indication of the second transmit power to the PDU generation block is based at least in part on selecting the second transmit power.

Aspect 3: The method of aspect 2, wherein the second transmit power is equal to the default transmit power if the remaining available transmit power is greater than the default transmit power; or the second transmit power is less than the default transmit power if the remaining available transmit power is less than the default transmit power.

Aspect 4: The method of any of aspects 1 through 3, further comprising: selecting the second transmit power for the second transmission based at least in part on the first transmit power for the first transmission and a mapping, wherein transmitting the indication of the second transmit power to the PDU generation block is based at least in part on selecting the second transmit power.

Aspect 5: The method of aspect 4, wherein the mapping is associated with a plurality of threshold transmit powers for the first transmission on the first radio link; and each threshold transmit power of the plurality of threshold transmit powers for the first transmission on the first radio link corresponds to a different transmit power for the second transmission on the second radio link in accordance with the mapping.

Aspect 6: The method of any of aspects 4 or 5, wherein the mapping indicates a correspondence between a first set of potential transmit powers for an ongoing transmission on the first radio link and a second set of potential transmit powers for an upcoming transmission on the second radio link that at least partially overlaps in time with the ongoing transmission on the first radio link; and a transmit power of the first set of potential transmit powers and a corresponding transmit power of the second set of potential transmit powers satisfy a transmit power constraint of the device based at least in part on the mapping.

Aspect 7: The method of any of aspects 1 through 6, further comprising: dropping the second transmission based at least in part on a transmit power delta between the default transmit power and the second transmit power satisfying a threshold transmit power delta associated with aborting the second transmission.

Aspect 8: The method of any of aspects 1 through 6, further comprising: obtaining a scheduling command associated with the second transmission that indicates the second transmission is a latency-sensitive transmission; and performing the second transmission in accordance with the second transmit power regardless of whether a transmit power delta between the default transmit power and the second transmit power satisfies a threshold transmit power delta associated with aborting the second transmission based at least in part on the second transmission being the latency-sensitive transmission.

Aspect 9: The method of any of aspects 1 through 6, further comprising: obtaining a scheduling command associated with the second transmission that indicates a mapping between a transmit power delta between the default transmit power and the second transmit power and a modulation and coding scheme index; selecting a modulation and coding scheme for the second transmission based at least in part on the transmit power delta and the mapping; and performing the second transmission in accordance with the second transmit power and the modulation and coding scheme.

Aspect 10: The method of any of aspects 1 through 9, further comprising: dropping a portion of the first transmission that overlaps in time with the second transmission based at least in part on the second transmission being associated with a higher priority than the first transmission and based at least in part on a transmit power delta between the default transmit power and the second transmit power; and performing the second transmission in accordance with the default transmit power based at least in part on dropping the portion of the first transmission that overlaps in time with the second transmission.

Aspect 11: The method of any of aspects 1 through 10, wherein the first transmission is associated with a relatively earlier start time than the second transmission; and the first transmission at least partially overlaps in time with the second transmission.

Aspect 12: The method of any of aspects 1 through 11, wherein communication on the first radio link is performed using a first radio frequency band; and communication on the second radio link is performed using a second radio frequency band.

Aspect 13: An apparatus for wireless communication at a device, comprising a processor; memory coupled with the processor; and instructions stored in the memory and executable by the processor to cause the apparatus to perform a method of any of aspects 1 through 12.

Aspect 14: An apparatus for wireless communication at a device, comprising at least one means for performing a method of any of aspects 1 through 12.

Aspect 15: A non-transitory computer-readable medium storing code for wireless communication at a device, the code comprising instructions executable by a processor to perform a method of any of aspects 1 through 12.

It should be noted that the methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, with reference to the WLAN 100 and the signaling diagram 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication at a device, comprising:
a processor;
memory coupled with the processor; and
instructions stored in the memory and executable by the processor to cause the apparatus to:
receive, from a first arbitration block associated with a first radio link and at a second arbitration block associated with a second radio link, an indication of a first transmit power for a first transmission on the first radio link;
receive, from a protocol data unit generation block associated with the second radio link and at the second arbitration block, a request for a default transmit power for a second transmission on the second radio link;
transmit, to the protocol data unit generation block from the second arbitration block, an indication of a second transmit power for the second transmission on the second radio link based at least in part on the request for the default transmit power and the indication of the first transmit power for the first transmission on the first radio link; and
transmit, to the first arbitration block from the second arbitration block, an indication of the second transmit power for the second transmission on the second radio link.

2. The apparatus of claim 1, wherein the instructions are further executable by the processor to cause the apparatus to:
determine a remaining available transmit power of the device based at least in part on the first transmit power for the first transmission and a transmit power constraint of the device;
compare the default transmit power to the remaining available transmit power; and
select the second transmit power for the second transmission based at least in part on comparing the default transmit power to the remaining available transmit power, wherein transmitting the indication of the second transmit power to the protocol data unit generation block is based at least in part on selecting the second transmit power.

3. The apparatus of claim 2, wherein the second transmit power is equal to the default transmit power if the remaining available transmit power is greater than the default transmit power; or the second transmit power is less than the default transmit power if the remaining available transmit power is less than the default transmit power.

4. The apparatus of claim 1, wherein the instructions are further executable by the processor to cause the apparatus to:
select the second transmit power for the second transmission based at least in part on the first transmit power for the first transmission and a mapping, wherein transmitting the indication of the second transmit power to the protocol data unit generation block is based at least in part on selecting the second transmit power.

5. The apparatus of claim 4, wherein the mapping is associated with a plurality of threshold transmit powers for the first transmission on the first radio link; and each threshold transmit power of the plurality of threshold transmit powers for the first transmission on the first radio link corresponds to a different transmit power for the second transmission on the second radio link in accordance with the mapping.

6. The apparatus of claim 4, wherein the mapping indicates a correspondence between a first set of potential transmit powers for an ongoing transmission on the first radio link and a second set of potential transmit powers for an upcoming transmission on the second radio link that at least partially overlaps in time with the ongoing transmission on the first radio link; and a transmit power of the first set of potential transmit powers and a corresponding transmit power of the second set of potential transmit powers satisfy a transmit power constraint of the device based at least in part on the mapping.

7. The apparatus of claim 1, wherein the instructions are further executable by the processor to cause the apparatus to:
drop the second transmission based at least in part on a transmit power delta between the default transmit power and the second transmit power satisfying a threshold transmit power delta associated with aborting the second transmission.

8. The apparatus of claim 1, wherein the instructions are further executable by the processor to cause the apparatus to:
obtain a scheduling command associated with the second transmission that indicates the second transmission is a latency-sensitive transmission; and
perform the second transmission in accordance with the second transmit power regardless of whether a transmit power delta between the default transmit power and the second transmit power satisfies a threshold transmit power delta associated with aborting the second transmission based at least in part on the second transmission being the latency-sensitive transmission.

9. The apparatus of claim 1, wherein the instructions are further executable by the processor to cause the apparatus to:
obtain a scheduling command associated with the second transmission that indicates a mapping between a transmit power delta between the default transmit power and the second transmit power and a modulation and coding scheme index;
select a modulation and coding scheme for the second transmission based at least in part on the transmit power delta and the mapping; and
perform the second transmission in accordance with the second transmit power and the modulation and coding scheme.

10. The apparatus of claim 1, wherein the instructions are further executable by the processor to cause the apparatus to:
drop a portion of the first transmission that overlaps in time with the second transmission based at least in part on the second transmission being associated with a higher priority than the first transmission and based at least in part on a transmit power delta between the default transmit power and the second transmit power; and
perform the second transmission in accordance with the default transmit power based at least in part on dropping the portion of the first transmission that overlaps in time with the second transmission.

11. The apparatus of claim 1, wherein the first transmission is associated with a relatively earlier start time than the second transmission; and the first transmission at least partially overlaps in time with the second transmission.

12. The apparatus of claim 1, wherein communication on the first radio link is performed using a first radio frequency band; and communication on the second radio link is performed using a second radio frequency band.

13. A method for wireless communication at a device, comprising:
receiving, from a first arbitration block associated with a first radio link and at a second arbitration block associated with a second radio link, an indication of a first transmit power for a first transmission on the first radio link;
receiving, from a protocol data unit generation block associated with the second radio link and at the second arbitration block, a request for a default transmit power for a second transmission on the second radio link;
transmitting, to the protocol data unit generation block from the second arbitration block, an indication of a second transmit power for the second transmission on the second radio link based at least in part on the request for the default transmit power and the indication of the first transmit power for the first transmission on the first radio link; and
transmitting, to the first arbitration block from the second arbitration block, an indication of the second transmit power for the second transmission on the second radio link.

14. The method of claim 13, further comprising:
determining a remaining available transmit power of the device based at least in part on the first transmit power for the first transmission and a transmit power constraint of the device;
comparing the default transmit power to the remaining available transmit power; and
selecting the second transmit power for the second transmission based at least in part on comparing the default transmit power to the remaining available transmit power, wherein transmitting the indication of the second transmit power to the protocol data unit generation block is based at least in part on selecting the second transmit power.

15. The method of claim 14, wherein the second transmit power is equal to the default transmit power if the remaining available transmit power is greater than the default transmit power; or the second transmit power is less than the default transmit power if the remaining available transmit power is less than the default transmit power.

16. The method of claim 13, further comprising:
selecting the second transmit power for the second transmission based at least in part on the first transmit power for the first transmission and a mapping, wherein transmitting the indication of the second transmit power to the protocol data unit generation block is based at least in part on selecting the second transmit power.

17. The method of claim 16, wherein the mapping is associated with a plurality of threshold transmit powers for the first transmission on the first radio link; and each threshold transmit power of the plurality of threshold transmit powers for the first transmission on the first radio link corresponds to a different transmit power for the second transmission on the second radio link in accordance with the mapping.

18. The method of claim 16, wherein the mapping indicates a correspondence between a first set of potential transmit powers for an ongoing transmission on the first radio link and a second set of potential transmit powers for an upcoming transmission on the second radio link that at least partially overlaps in time with the ongoing transmission on the first radio link; and a transmit power of the first set of potential transmit powers and a corresponding transmit power of the second set of potential transmit powers satisfy a transmit power constraint of the device based at least in part on the mapping.

19. The method of claim 13, further comprising:
dropping the second transmission based at least in part on a transmit power delta between the default transmit power and the second transmit power satisfying a threshold transmit power delta associated with aborting the second transmission.

20. The method of claim 13, further comprising:
obtaining a scheduling command associated with the second transmission that indicates the second transmission is a latency-sensitive transmission; and
performing the second transmission in accordance with the second transmit power regardless of whether a transmit power delta between the default transmit power and the second transmit power satisfies a threshold transmit power delta associated with aborting the second transmission based at least in part on the second transmission being the latency-sensitive transmission.

21. The method of claim 13, further comprising:
obtaining a scheduling command associated with the second transmission that indicates a mapping between a transmit power delta between the default transmit power and the second transmit power and a modulation and coding scheme index;
selecting a modulation and coding scheme for the second transmission based at least in part on the transmit power delta and the mapping; and
performing the second transmission in accordance with the second transmit power and the modulation and coding scheme.

22. The method of claim 13, further comprising:
dropping a portion of the first transmission that overlaps in time with the second transmission based at least in part on the second transmission being associated with a higher priority than the first transmission and based at least in part on a transmit power delta between the default transmit power and the second transmit power; and
performing the second transmission in accordance with the default transmit power based at least in part on dropping the portion of the first transmission that overlaps in time with the second transmission.

23. The method of claim 13, wherein the first transmission is associated with a relatively earlier start time than the second transmission; and the first transmission at least partially overlaps in time with the second transmission.

24. The method of claim 13, wherein communication on the first radio link is performed using a first radio frequency band; and communication on the second radio link is performed using a second radio frequency band.

25. An apparatus for wireless communication at a device, comprising:
means for receiving, from a first arbitration block associated with a first radio link and at a second arbitration block associated with a second radio link, an indication of a first transmit power for a first transmission on the first radio link;
means for receiving, from a protocol data unit generation block associated with the second radio link and at the second arbitration block, a request for a default transmit power for a second transmission on the second radio link;
means for transmitting, to the protocol data unit generation block from the second arbitration block, an indication of a second transmit power for the second transmission on the second radio link based at least in part on the request for the default transmit power and the indication of the first transmit power for the first transmission on the first radio link; and
means for transmitting, to the first arbitration block from the second arbitration block, an indication of the second transmit power for the second transmission on the second radio link.

26. The apparatus of claim 25, further comprising:
means for determining a remaining available transmit power of the device based at least in part on the first transmit power for the first transmission and a transmit power constraint of the device;
means for comparing the default transmit power to the remaining available transmit power; and
means for selecting the second transmit power for the second transmission based at least in part on comparing the default transmit power to the remaining available transmit power, wherein transmitting the indication of the second transmit power to the protocol data unit generation block is based at least in part on selecting the second transmit power.

27. The apparatus of claim 26, wherein the second transmit power is equal to the default transmit power if the remaining available transmit power is greater than the default transmit power; or the second transmit power is less than the default transmit power if the remaining available transmit power is less than the default transmit power.

28. The apparatus of claim 25, further comprising:
means for selecting the second transmit power for the second transmission based at least in part on the first transmit power for the first transmission and a mapping, wherein transmitting the indication of the second transmit power to the protocol data unit generation block is based at least in part on selecting the second transmit power.

29. A non-transitory computer-readable medium storing code for wireless communication at a device, the code comprising instructions executable by a processor to:
receive, from a first arbitration block associated with a first radio link and at a second arbitration block associated with a second radio link, an indication of a first transmit power for a first transmission on the first radio link;
receive, from a protocol data unit generation block associated with the second radio link and at the second arbitration block, a request for a default transmit power for a second transmission on the second radio link;
transmit, to the protocol data unit generation block from the second arbitration block, an indication of a second transmit power for the second transmission on the second radio link based at least in part on the request for the default transmit power and the indication of the first transmit power for the first transmission on the first radio link; and
transmit, to the first arbitration block from the second arbitration block, an indication of the second transmit power for the second transmission on the second radio link.

30. The non-transitory computer-readable medium of claim 29, wherein the instructions are further executable by the processor to:
determine a remaining available transmit power of the device based at least in part on the first transmit power for the first transmission and a transmit power constraint of the device;
compare the default transmit power to the remaining available transmit power; and
select the second transmit power for the second transmission based at least in part on comparing the default transmit power to the remaining available transmit power, wherein transmitting the indication of the second transmit power to the protocol data unit generation block is based at least in part on selecting the second transmit power.
